(19) United States
(12) Patent Application Publication
(10) Pub. No.: US 2011/0098524 A1
(43) Pub. Date: Apr. 28, 2011

(54) COLLECTOR DEVICE FOR CATTLE EMBRYOS

(76) Inventor: Carlos Alberto BARCELO ROJAS, Villahermosa (MX)

(21) Appl. No.: 12/605,044

(22) Filed: Oct. 23, 2009

(51) Int. Cl. A61D 19/04

(52) U.S. Cl. 600/34

(57) ABSTRACT

The present invention relates to an embryos collector system used for the collection and careful selection of embryos, which maintains the fluid control from the uterus discharge fluids inside the collector device and the control of displacement of the embryos and mucosal in the interior of the device. This system includes a conduit system free of internal collision points where the embryos can safely navigate to a section on the device, in which the direction, force, and speed of the turbulent currents are controlled; thus, the embryos are not subjected to any trauma, cannot be trapped by the mucosal; nor dragged by the filtration mesh.

### FIELD OF THE INVENTION

The present invention relates to a collector device for cattle embryos. The embryos collector of the present invention comprises a device having a system for the careful and safe recovery of embryos, keeping the control of the uterus fluid discharge, the control of embryos movements, and the mucosal inside the receptacle, to be manipulated and removed promptly and efficiently.

### BACKGROUND OF THE INVENTION

The present devices to collect cattle and horse embryos are basically designed to filter the culture medium and then retain the embryos on a mesh, in a small volume of culture medium. This technological conception emerges from the need to prevent the localization time of the embryos inside the precipitated vessels and probes that were previously used to retrieve them in a large volume of culture medium. In this way, the technological idea arose of “filtering the excess and retaining the embryos with a mesh”, for this reason all the currently used models based their designs in the speed at which the excess leave the mesh, and do not take into consideration a safe way to transport, retrieve, and locate the healthy embryos, to the degree that is still normally accepted to find them with the pellucid zone (coating film that has the embryo) fractured, with or without embryo residues.

Current filters, although different in shape, use a similar hose system to transport the embryos since they leave the uterus through the Foley catheter, until they reach the receiver filter, are characterized for having a bifurcation and high-risk internal connection for the safe transportation, also because of the way they pour the uterus discharge in the interior of each of the different re-collector devices, all of them do it in a violent cascade that collides against the mesh or against the inner walls.

In this hose system, the embryos surf through conduits having prominent impact internal points, where often the embryos become fragmented before falling in cascade against the bottom of the collector device.

Another distinguishing feature to the current models is that the uterus, when it is deposited inside the collector device, creates a turbulence, constantly and violently removing the embryos and mucosal until they are trapped on the mesh; this design unfortunately, encourages physical abuse of the embryos and exposes them to be embedded in the mucous membranes, where it is very difficult to see, and worse still, to extract them.

The drainage system is another special feature that is similar to the current models. This system exposes the embryos to be trapped on the mesh, stuck to the mucous membranes, and then the draining drags everything to the filtration mesh, and usually the ends of mucosal breached the mesh wrapping of any embryo that can be caught.

In what has been mentioned, there is another undesirable, but real, technical feature in all current models, in that it is impossible to wash the mesh in the correct direction to detach the mucosal trapped in it; all the technical operators who want to detach the mucosa trapped in the mesh are forced to use a jet wash to try to separate the mucus. Washing and rinsing the mesh correctly means retrieving the majority of embryos, however many go unnoticed among the mucus that fail to be detached, or covered, hidden to the microscope eye; these are some undesirable technical characteristics.

Another problem of the current system is caused by the location of the filtration mesh in the inside of the device, such as: 1) the ones that have the mesh in the bottom of a glass; 2) the ones that have the mesh in one side; and 3) the ones that have the mesh in the top of a drainage tower.

Case 1. The System that has the Mesh in the Bottom of a Glass

These systems are the simpler technology. They are washed by applying culture medium under pressure over the mesh, pouring the contents in one or two devices to find the embryos. This is a relatively simple process, but with the following disadvantages:

The diameter of the solution under pressure applied with the syringe against the mesh is three times bigger than the embryo and can cause the embryo severe traumatic damage and possibly death.

A large number of embryos are lost while passing unnoticed between the fragments of mucous that fail and become detached from the mesh, in the same way, some pass unnoticed invisibly to the microscope, because they are virtually embedded in the mucous membranes and cannot be seen.

Another inconvenience occurs when passing the embryos from the filter to the device for their search, because they can be traumatized and become damaged.

Case 2. The System that has the Mesh in One Side

In these systems it is very difficult to detach the embryos and the mucosal from the filtration mesh. Three models that are known are:

a) the one that has the mesh alongside;
b) the one that has the big mesh in a side; and
c) the one that has a small mesh in a side.

In all of these models it is virtually impossible for the fluid applied under pressure over the mesh to wash, as it can generate a countercurrent that detaches from the natural side that is stuck there. This model already became obsolete, leaving the market of this disadvantage, and because it also recommends washing apart the mesh, rescue the embryos and the mucosal by suction with a syringe directly in the mesh.

Moreover, in this type of model, it is not only difficult to detach what is stuck, but it is also difficult to wash the mesh without filling the device used to locate the embryos, because it requires a lot of culture medium to do this step correctly, which implies a high technical level, thus cannot be done easily, unless we have available one or more extra devices, for pouring the portion that cannot be fixed in the original container.

Therefore, in these two models there are always going to be a large amount of mucosal stuck in the mesh, in which part of the collected embryos remain hidden.

The technology that has a small mesh in the side, unlike the previous, offers less resistance to the correct wash of the mesh, precisely because of the size of the mesh, which facilitates that the mesh can be washed more easily than previous technologies, although certainly does not guarantee that everything can become detached.

Case 3—The System that has the Mesh in the Top of a Drainage and Filtering Tower

In this system, the filtration and drainage tower rises through the center of the device and is extremely difficult to extract the mucous and embryos that attach to the mesh, because it cannot be washed in the correct direction to detach what is stuck in the filtration mesh, neither can it be used with a lot of liquid, without over filling the device for the search of embryos, since the problem is aggravated by the fluid excess.

Another important aspect of filtration technologies known in this field, comprises the search for embryos with a microscope, but this work is affected by different technical factors that by one way or another cause the loss of unnoticed embryos.

None of the already known technologies provide security for finding 100% of embryos that drain from the uterus.

Then, according to the antecedent of the state of the techniques, the filters currently known are divided into two groups:

(a) Those that require devices for the search.

In the group that requires search devices, we have the filtration system with a mesh in the bottom, which needs at least two Petri dishes for searching the embryos. On these devices, the operating time plays a very important role, however the main enemies of the search are the following operational issues:

1. Foam presence, which prevents the location of embryos.
2. Mucus and embryos that easily adhere to the foam.
3. Difficulty to view and release the embryos embedded in the mucus.
4. Little visibility of embryos in the vertical perimeter of the Petri dishes.
5. Inoperative accessories to separate the mucus embryos.
b) Those that supposedly do not require devices for the search

The devices that do not require devices for the search, all have integrated an area for locating the embryos, being the main operational disadvantages in most of them, the quantity of liquid stored and the depth of the medium, factors that affect the search and location of the embryos in extreme degrees in different ways:

(a) with constant spills over the base of the microscope because the search device is filled up to the top when the filtering mesh is washed to detach the embryos and mucosal;
(b) with the mucous membranes flotation and embryos because the depth does not allow to view with the microscope bottom and the surface at the same time, forcing the technician to wait several hours until they precipitate;
(c) with the size of the search area because in most of them the size is similar to the conventional search box.

Problems that affect mainly the system where the side mesh occupies one side of the wall, and the system where the mesh filter is located in a elevated tower; because in these two models the search area is very large, as large as conventional, not reducing at all the operating time or the foam problem that forms while trying to wash the mesh, because both spill liquid over the microscope when attempting to locate the embryos obstructing the visibility and because the two accumulate too much fluid increasing the depth and obstructing the search, especially the one that has large mesh on the side, because this spills without filtering creating the possibility of losing the embryos attached to the floating mucous.

Another version of devices that supposedly does not require devices for searching is the one that has a very small circular search area and delimited by the mesh of filtration. This system technologically left the market in view that all the embryos and mucous were attached to the mesh, which prevented them from being seen, in addition to the excess of stripes and numbers located in the bottom that made them even more difficult to find.

A latest version of this type of device that recently entered the market, to search for and locate embryos, does not improve the search according to the previous system, because the culture volume accumulated is very deep and does not allow viewing at the same time what lies at the bottom and what floats on the surface. In addition, it is necessary to wait for a long time for the suspended mucosal to precipitate to be able to review them, and neither improves the collection of embryos because it uses the same hose system with bifurcations and connections with internal borders that put at risk the integrity of the embryo, while pours in a very violent manner the uterus discharge against the bottom of the device, generalizing the chance of suffering severe trauma. Neither improves the recovery of embryos since all will go along with the mucosal directly in the filtration mesh, causing first the common problem when trying to detach them from the mesh, and second because it is very easy for them to be embedded in mucosal allowing the loss of unnoticed embryo, because it is very difficult to detach them.

Finally, mentioning another technological system that is not in the market, but it is an ancestor of the state of the art, even of the three most recent models, but much more efficient than all of them because it introduces the immersion system to eliminate the foam formation. This system greatly reduces the embryonic trauma by the same principle and also includes the concept of chamber with sloping sidewalls, which maintains the embryos in an always visible area, allowing to precisely focus with the microscope. This technological model, innovates with respect to the other technologies, because the lid of the collector is designed with an admission valve that ensures a connection without internal borders between the hose system and collector system, valve that decreases the chances of embryonic trauma, because it allows the free transit of the embryos to the bottom of the collector, where they are deposited and immersed in the uterus discharge and directed toward the opposite wall to eliminate the foaming. This model was technologically designed thinking that the embryos would tend to float comfortably at the bottom and then precipitate; it also was considered that the force of the uterus discharge would be controlled by the immersion principle jointly with the expulsion principle by spill of the excess, which did not happen, because the discharge force is strong enough to impulse the embryos and mucosal to the mesh, resulting in a much easier way, having to wash the mesh to be sure that the majority of embryos could be recovered.

This latest model for collecting embryos, also introduced two new technological systems of filtration and drainage:

The principal superior lateral filtration system and drainage that expels at the time of collecting.

The secondary lateral system that evacuates the excess of culture medium that is not required for the search of the embryos with the microscope.

The objective being in both systems, avoiding that the embryos and mucosal arrived to the mesh to avoid washing them, which did not occur because the uterus discharge and the drainage system suction forces are strong enough to drag them, in addition to remove and hit them against the walls, which causes embryonic trauma, not overcoming the technology trauma, thereby not solving the problem of the embryos and mucosal attached into the mesh. Neither resolves the problems of washing the mesh with under pressure syringe, nor the problem with the foam that is generated when trying to detach them, moreover, the turbulence that is generated with the uterus discharge in the interior of the device cannot be controlled, and does not eliminate the problem of trauma because damaged embryos can still be found.

Having described the previous technologies as background, it can be said that the concept of “filtering excess” closed a chapter in the history of the collection, recovery, and location of embryos. A new technological proposal converts it as a secondary aspect replacing it with another more important concept, that has to do with rescuing the loss of unnoticed embryos, caused by the designs directly on the filtration speed, without taking into account that the embryos are small and fragile cellular structures that can be easily damaged.

In view of the above, the present inventor realized the need to create a new highly efficient technology to ensure the health, easy, and efficient retrieval of embryos and mucosal avoiding embryonic trauma; removing the washing of meshes, foam, and facilitating the optimal search without using secondary equipment for their recovery.

### SUMMARY OF THE PRESENT INVENTION

The present invention is directed to an embryos collector system used for the collection and careful selection of the embryos, which maintains the control of fluids from the uterus discharge to the interior of the collector device, the control of the displacement of the embryos and the mucosa in the interior of the apparatus. This system includes an arrangement of conduits having free internal collision points where the embryos can safely navigate to a section of the device, and in which the direction, force, and speed of the turbulent fluid is controlled, in such a way that the embryos do not suffer trauma; are not trapped by the mucous membranes; or dragged to the filtration mesh.

The system for collecting embryos in accordance with the present invention comprises:

a supply valve, wherein the supply valve includes one first end and a second end and is adapted to connect on the first end to a culture medium source;

a supply hose connected to the second end of the supply valve;

an action valve, wherein the action valve contains a first end, a second end, a third end, and a fourth end, wherein the first end is connected to the supply hose;

a discharge hose, wherein the discharge hose includes a first end and a second end, wherein the first end of the discharge hose is connected to the second end of the action valve;

a collector device connected to the second end of the discharge hose;

wherein the collector device includes an embryos receptor, the main filtration and drainage system, a secondary filtration and drainage system, and a fastener.

The embryos receptor comprises at least two fins on the exterior side, which divide the collector device in at least three essential chambers for the management of fluids.

In addition, the chambers are intercommunicated through channels, siphons, and outfalls that work together with the main drainage system and the secondary drainage system to control what is admitted and released from each one of the chambers.

The supply valve comprises:

in the first end a hollow perforation tip that connects the supply valve with the culture source;

in the second end a transparent flow chamber comprising a cylinder having controlled movement guides and a float, movement guides control the movements of the float between an admission orifice and a discharge orifice.

The hollow perforation tip is conical and multi-dimensional to perforate and tightly seal different entrance orifice diameters. In addition, the cylinder is transparent, and the float controls by gravity forces the admission, and automatic closing of the supply valve against the flow. The float allows the flow of the culture medium only in one direction by the gravity force. The action valve is a double action valve and comprises:

a fixed section;
a mobile section; and
a plug.

The fixed section valve includes:

a supply duct that feeds the system;
a discharge conduit; and
a chamber;
wherein in the interior of the chamber a mobile cone is connected, slides, and moves in a controlled manner through a series of sound strips with airtight adjustment.

The end of the supply duct and the end of the discharge duct are slanted to facilitate the insertion of the hose and to form a connection without internal borders that can prevent the free flow of embryos in any direction.

The mobile section of the valve is adapted to be connected to the Foley catheter;

wherein the mobile section is in charge of opening, closing, and hiding the supply duct producing with its movement an indicator sound;

wherein the mobile section has an internal form shaped as a funnel for the careful receipt of the embryos;

wherein because of the funnel shape of the Foley catheter the catheter is connected inside the funnel forming a continuous duct without borders and walls, which obstruct the free movement of the embryos.

The supply and discharge hoses are filled by the action of the plug.

In addition, the double action valve includes a sound indicator system of actions which emit a particular sound when it is opened to give pass to the supply of culture medium, and other sound when hidden the bifurcation to give pass to the uterus discharge.

The first chamber is the embryos receptor chamber, wherein the second chamber is the shelter chamber; wherein the third chamber is the excess chamber; and wherein the chambers are contiguous and are also communicated.

The shelter chamber presses the fluid layer to allow that its remains in the bottom as it fills up until it spills the layer on the surface, without mixing that supplied with what is discharged; wherein the chamber includes a small communicating tube that serves to automatically regulate the level between the different chambers, either when the fluid is discharged by the main drainage or when it is drained from the secondary drainage.

The excess chamber includes the main filtration and drainage system and the secondary filtration and drainage system.

The embryos receptor also includes a siphon that works automatically to regulate the fluid level between the different chambers.

The collector device also includes a cap having an admission valve made of an elastic material that accepts and seals different hose diameters; where the elastic material has memory to allow the admission valve to close by itself when the hose is removed.

The main filtration system is mobile and can be disassembled and rotated; in addition includes a gate to prevent the entry of powder or any atmospheric pollutant into the device.

The secondary drainage system includes a cap and a funnel;

wherein the cap includes a slot;

wherein the funnel includes a slot;

wherein when the cap rotates, the slot in the plug matches the slot of the funnel controlling the output speed of the fluid.

The bottom of the collector device is equipped with two search areas for the location of embryos, the first area is located in the center of the bottom of the collector device and is enclosed by a wall that rises diagonally on both sides to finish on an edge in order to facilitate the visibility; and the second area that surrounds the first area and occupies the rest of the bottom of the device.

The foregoing has outlined some of the more pertinent objectives of the present invention. These objectives should be construed to be merely illustrative of some of the more pertinent and featured applications of the invention. Many other beneficial results can be obtained by applying the disclosed invention in a different manner or modifying the invention within the scope of the disclosure. Accordingly, other objectives and in order to more fully understand the invention, refer to the summary of the invention and the detailed description describing the preferred embodiment In addition to the scope of the invention defined by the claims taken in conjunction with the accompanying drawings.

### BRIEF DESCRIPTION OF THE FIGURES

The accompanying drawings, which are incorporated in and constitute a part of this specification, illustrate several implementations of the invention and, together with the description, serve to explain the advantages and principles of the invention.

FIG. 1 shows a perspective frontal view of the embryos collector system in accordance with the present invention showing a triple action valve.

FIG. 2 shows a side view of the embryos collector system in accordance with FIG. 1.

FIG. 3 shows a perspective top view of the embryos collector system according to FIG. 1.

FIG. 4 shows a perspective bottom view of the embryos collector system according to FIG. 1.

FIG. 5a shows a front view of the supply valve in accordance with the present invention.

FIGS. 5b-5q show detailed views of the different parts that form the supply valve in accordance with FIG. 5a.

FIG. 6a shows a perspective front view of the double action valve according to one of the embodiments of the present invention.

FIG. 6b shows a top view of the double action valve in accordance with FIG. 6a.

FIG. 6c shows a front view of the double action valve in accordance with FIG. 6a.

FIG. 6d shows a bottom view of the double action valve in accordance with FIG. 6a.

FIG. 6e shows an isometric view of the double action valve in accordance with FIG. 6a.

FIG. 6f shows a right side view of the double action valve in accordance with FIG. 6a.

FIGS. 6g-6j show detailed views of the different parts of the double action valve in accordance with FIG. 6a.

FIG. 7a shows a perspective front view of the triple action valve according to another embodiment of the present invention.

FIGS. 7b-7c show detailed transversal views of the different parts of the triple action valve according to FIG. 7a.

FIG. 8a shows a perspective top view of the embryos collector device in accordance with the present invention.

FIG. 8b shows a perspective side view of the embryos collector device of FIG. 8a.

FIG. 8c shows a side view of the embryos collector device of FIG. 8a showing the lid.

FIG. 8d shows a perspective side view of the embryos collector device of FIG. 8a showing the lid.

FIG. 8e shows another side view of the embryos collector device of FIG. 8a showing the lid.

FIG. 8f shows another side view of the embryos collector device of FIG. 8a showing the needle retention system.

FIG. 8g shows another top view of the embryos collector device of FIG. 8a showing the needle retention system.

FIG. 9 shows a perspective side view of the embryos receptor device that divides into chambers the inside of the collector device.

FIG. 10 shows a perspective view of the lid of the collector device.

FIG. 11 shows a perspective side view of the gate of the main funnel drainage.

FIG. 12a shows a perspective side view of the discharge gate of the secondary filtration and drainage system.

FIG. 12b shows a detailed view of one of the elements that are part of the discharge gate of the secondary filtration and drainage system.

FIG. 12c shows a detailed view of other elements that are part of the discharge gate of the secondary filtration and drainage system.

### DETAILED DESCRIPTION OF THE INVENTION

The present system invention provides an automatic embryos collector system which relates to the receipt, transportation, and the careful handling of the uterus discharge inside the collector device.

The present system provides a significant improvement over all the known art devices since the embryos leave the uterus through the Foley catheter until they arrive to the collector device and pass through a system of ducts free of collision points, where the direction and force of the turbulent flow generated by each discharge is controlled, thus, the embryos can only move to specific and predetermined sites of the device where they are located immediately. The system according to the present invention safely retrieves 100% of the embryos without producing bangs or scratches.

Below is a description of the invention, using as a base the figures with illustrative character and not limiting them.

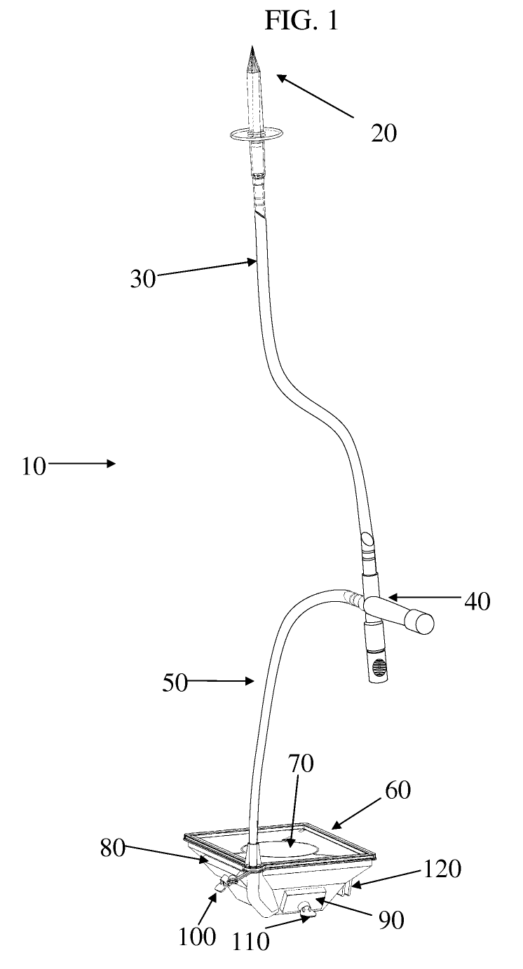

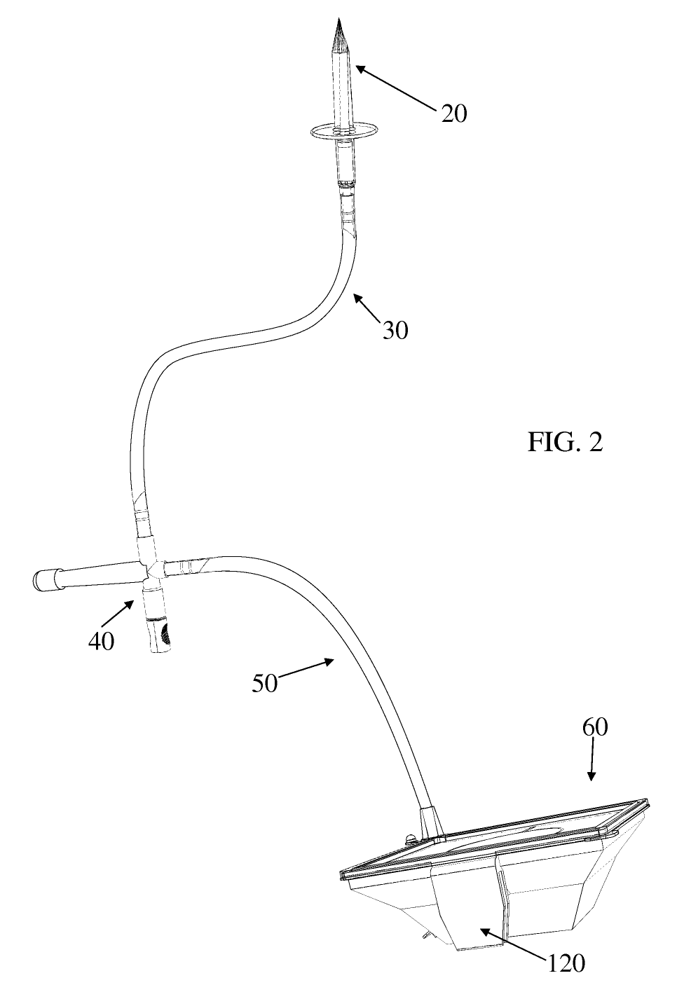

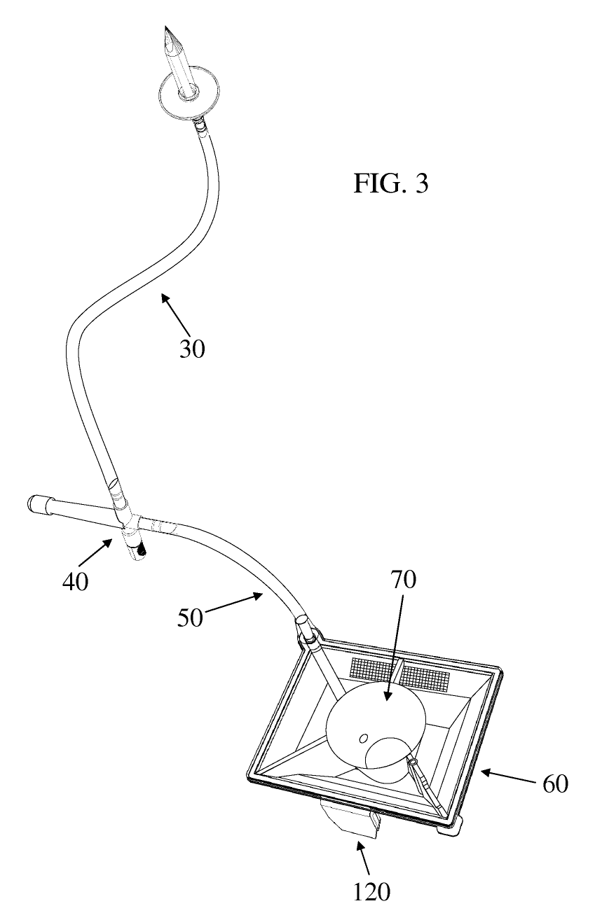

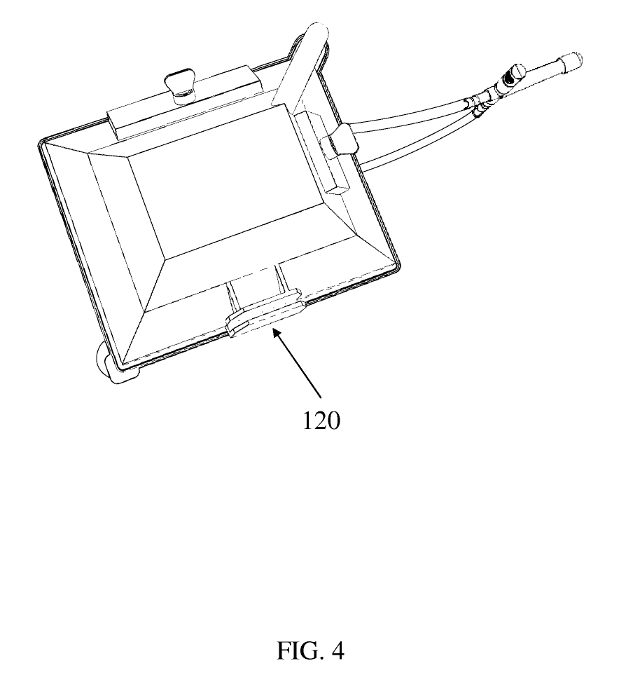

FIG. 1 shows a perspective front view of the embryos collector system 10 according to the present invention. The system 10 comprises:

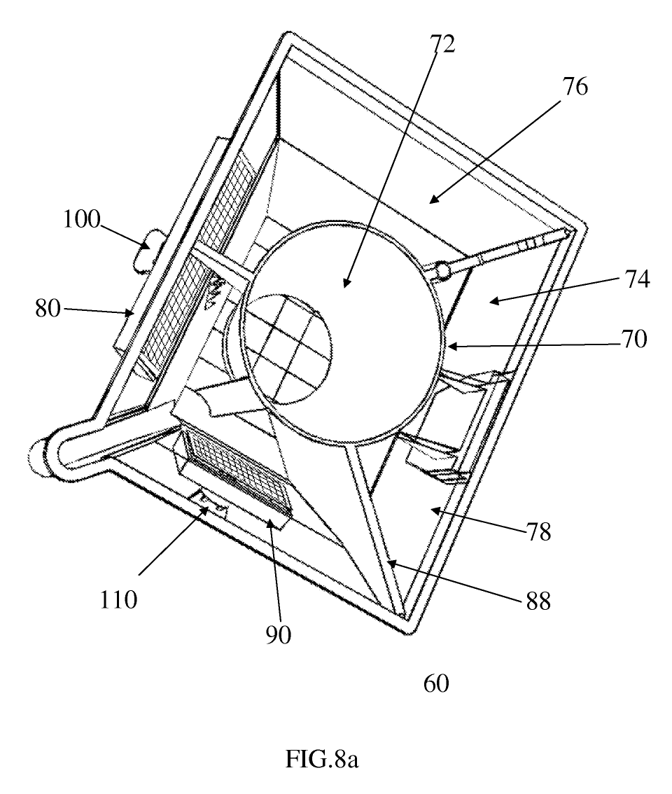

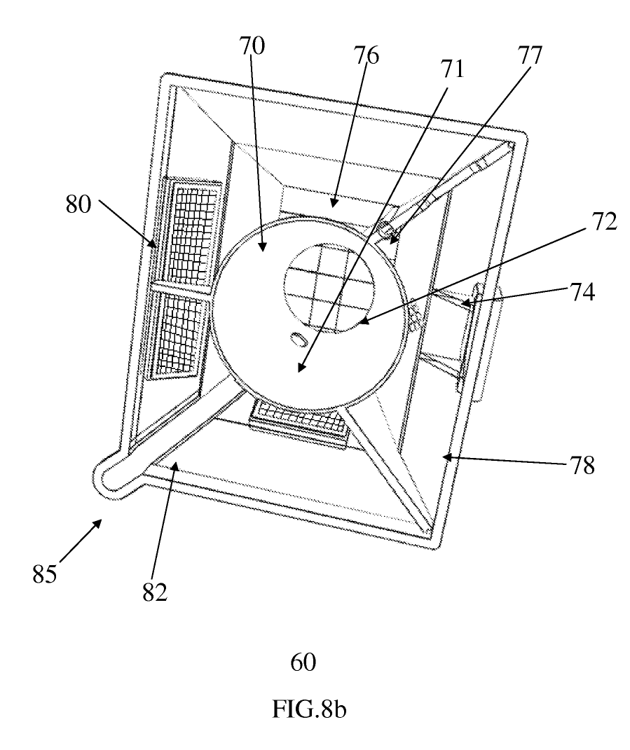

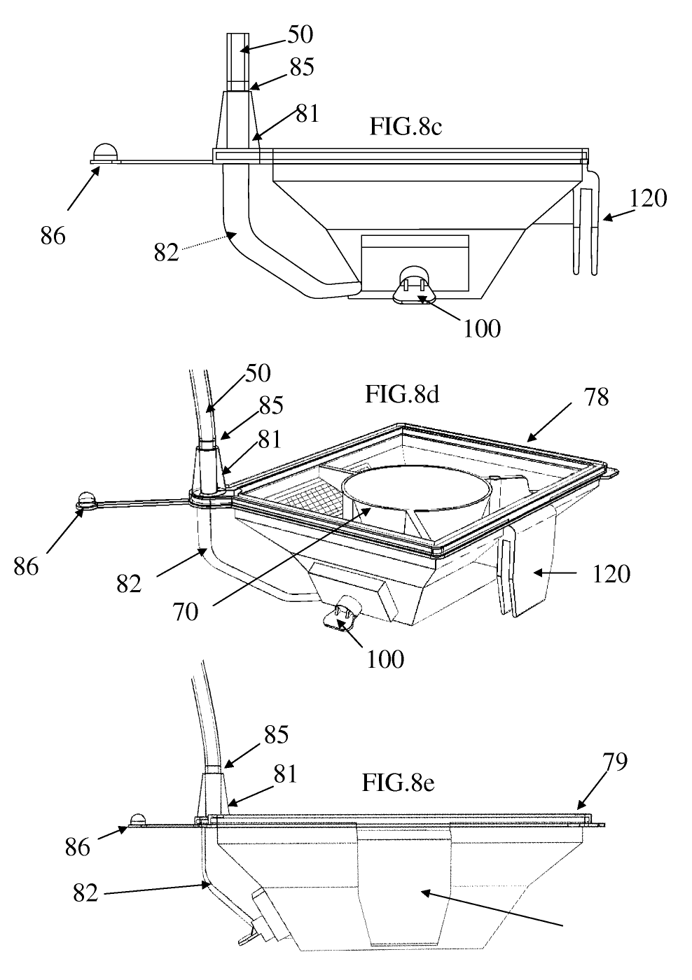

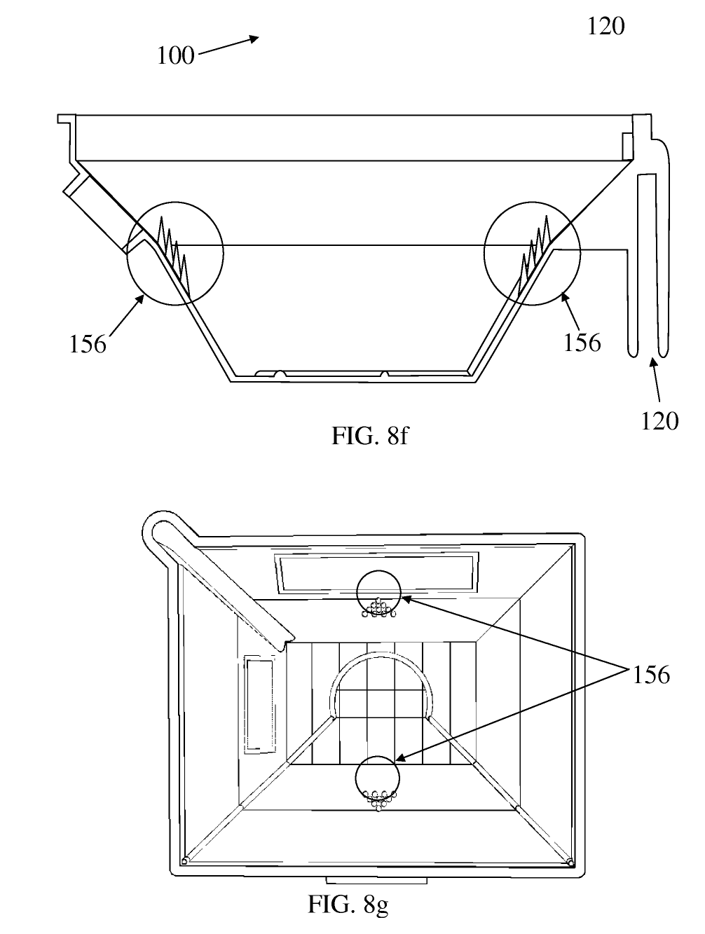

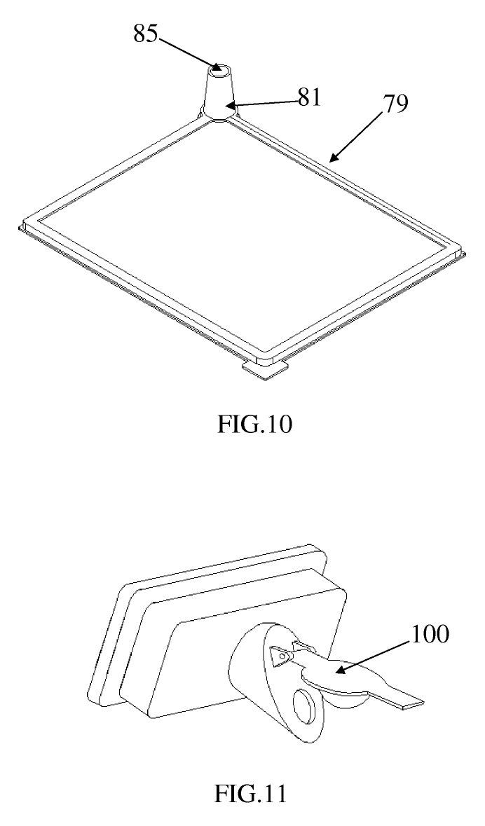

a supply valve 20;
a supply hose 30;
an action valve 40;
a discharge hose 50;
a collector device 60;
wherein the collector device 60 includes an embryos receptor 70, the main filtration and drainage system 80, and the secondary filtration and drainage system 90 (FIG. 8a), and the system for the retention and handling of mucous 156 (FIG. 8f).

In addition, the collector device 60 includes the main funnel gate 100, the excess control valve of the secondary funnel 110, and the fastener 120.

The system of the present invention comprises a novel hose system with a device to control the fluids leaving the culture medium source and the ones that enter the system from the uterus. This section of the system includes a supply valve 20, a supply hose 30, the action valve 40, and the discharge hose 50. This is characterized because these components are connected to each other forming a system which is free from internal collision points, so that all the connections between its parts do not form internal points.

This allows the embryos to safely navigate through their journey until the next section of the system, which controls the direction and force of the turbulent current.

### Supply Valve

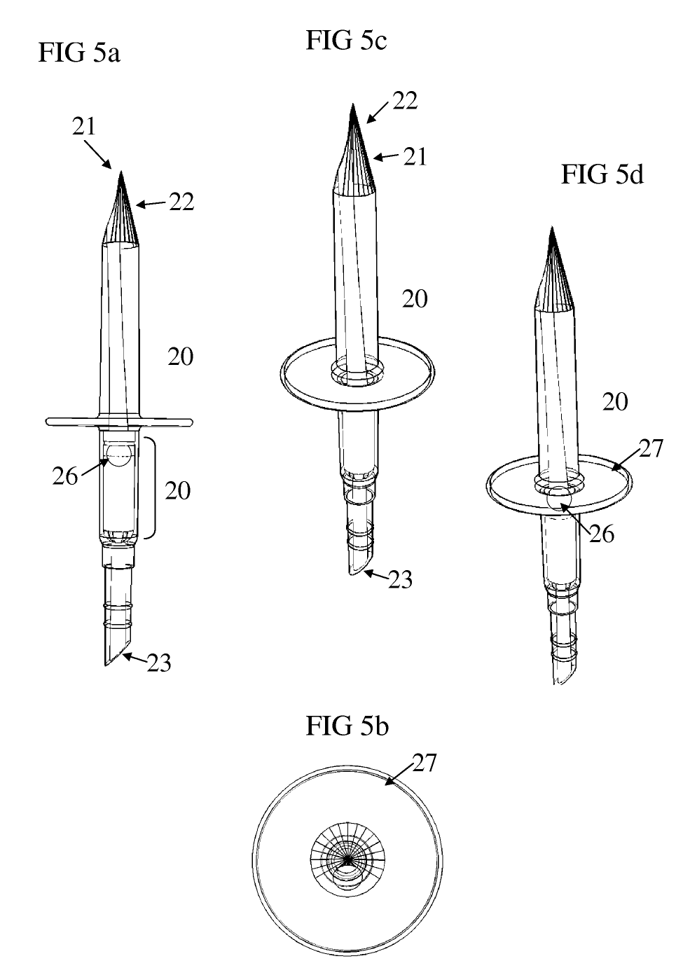

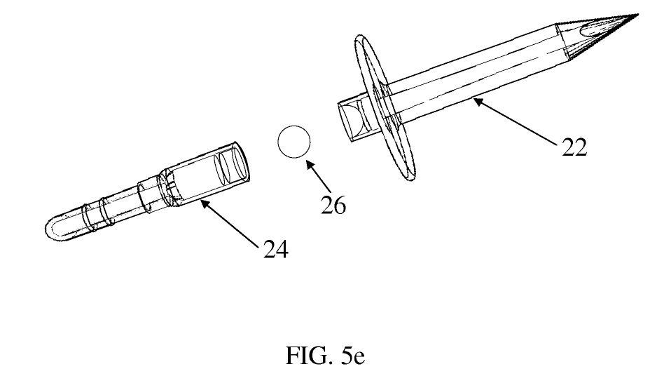

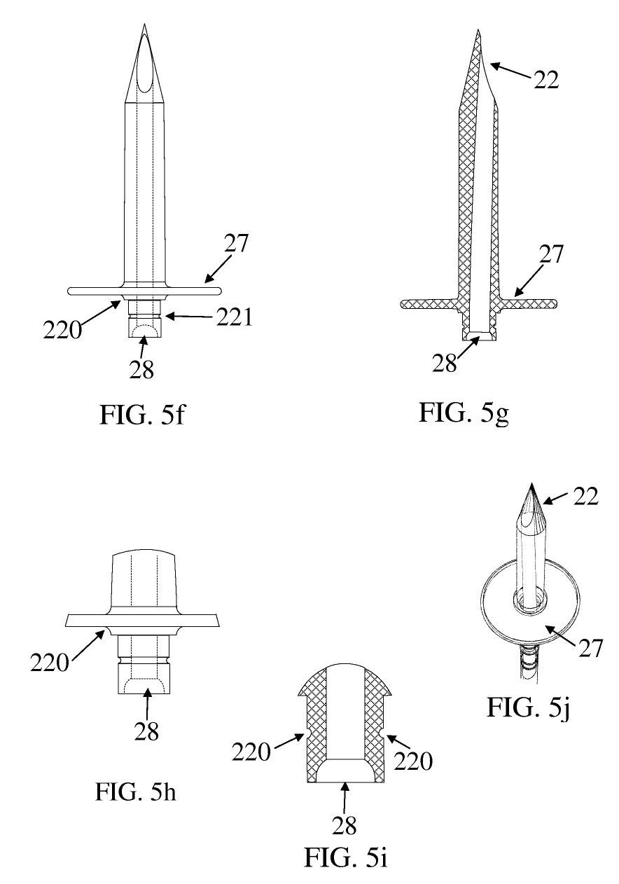

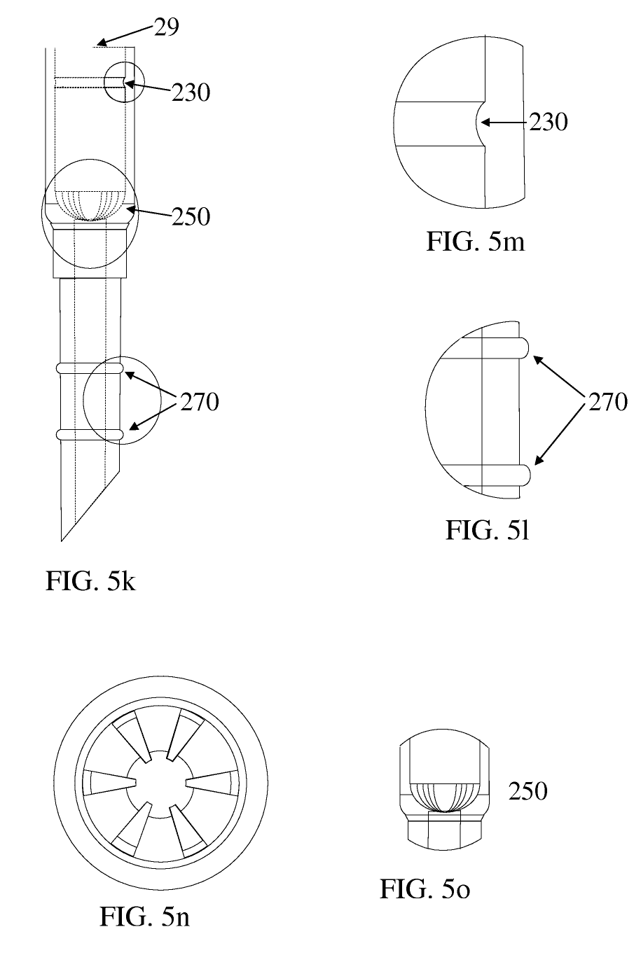

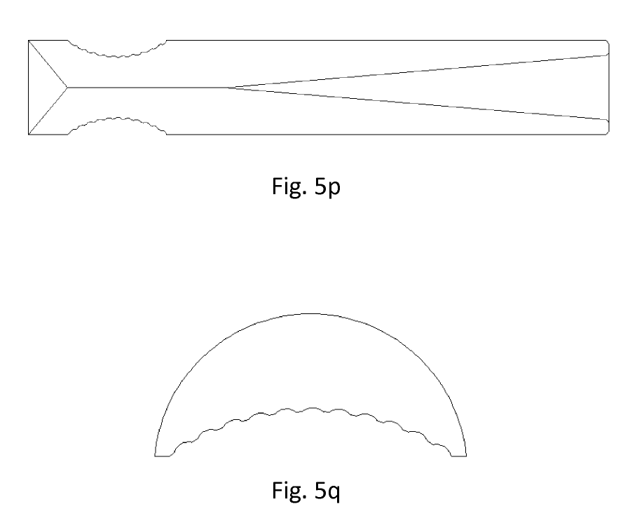

FIG. 5a shows a supply valve 20 in accordance with the present invention. The supply valve 20 has a first end 21 and a second end 23. The first end 21 contains a hollow perforated tip 22 to connect the collector system 10 with a source of growing medium (not shown). The second end 23 has a transparent flow chamber comprising a cylinder 24 having controlled movement guides and a float 26, which together, allow the free flow of fluid by gravity and also prevent the flow from returning to the culture medium source.

As the cylinder 24 is transparent (FIGS. 5c-5e), it allows to easily watch the movements of the float 26 to know whether or not the liquid is flowing, and to prevent human error, which could allow the embryos to enter and pass unnoticed inside the culture medium source (not shown).

FIG. 5b shows the support 27 which divides the supply valve 20 into two ends. The support 27 serves to support the thumb and the index fingers of the user to forcefully push the supply valve 20 in order to insert and perforate the source culture medium (not shown); another feature of the support is transmitted by the high relief that emerges from the bottom which serves to center, connect, and hermetically seal the flow chamber.

FIG. 5f refers to the valve tip, characterized first because it has a perforation tip 22 used to perforate and admit the culture medium flow. The valve tip is characterized by its conical and multi-dimensional external configuration which can be inserted and sealed adapting to the particular structure of the plug of the particular culture medium that is required to be perforated; second because it has a support plate 27 that divides the supply valve 20 at both ends and serves for manipulating supporting the thumb and the index fingers of the user to vigorously push the supply valve 20 to insert and pierce the culture medium source (not shown), another feature of the support plate 27 is transmitted by the high relief 220 emerging from the bottom which serves to center, connect, and hermetically seal the flow chamber, and finally, a second end 28 to discharge the flow that is characterized first because the discharge hole has the particular form of a float 26, because if any human error, the fluid return is allowed, and the float is automatically and hermetically closed preventing the return of the flow toward the source, and second is characterized by the groove 221 of the external part that serves along with the relief 220 to connect and tightly seal in one step indicated with a sound, the flow chamber.

FIG. 5 relates to the flow chamber, this part is characterized in several ways, first because it has a first end 29 which is inserted and connected by its low side with the tip of the valve, characterized because in its inside has a counter notch 230 that connects and tightly seals against the notch of the valve tip, second because the interior has a chamber 240 that allows the float to tightly move to reach the guides 250 that configured the lower part of the chamber 240, which in turn is characterized for retaining float 26 allowing the passage of the fluid and preventing the obstruction of the discharge duct, third because the chamber 240 is sufficiently transparent to allow seeing the movements of the float, fourth because it has a second end characterized by a slant 260 that facilitates the inserting of the supply hose, and because of the two airtight adjustment rings 270 that facilitate tying the hose avoiding the use of adhesives.

### Supply Hose

One of the ends of the supply hose 30 is connected to the second end of the supply valve 20.

The supply hose 30 may be made of any material that meets the requirements in this technical field. A person skilled in the art may decide the best material and size of the supply hose that needs to be used depending on each particular case.

One embodiment of the present invention uses any transparent material which allows observing the direction of the material flow that passes through the supply hose 30.

### Action Valve

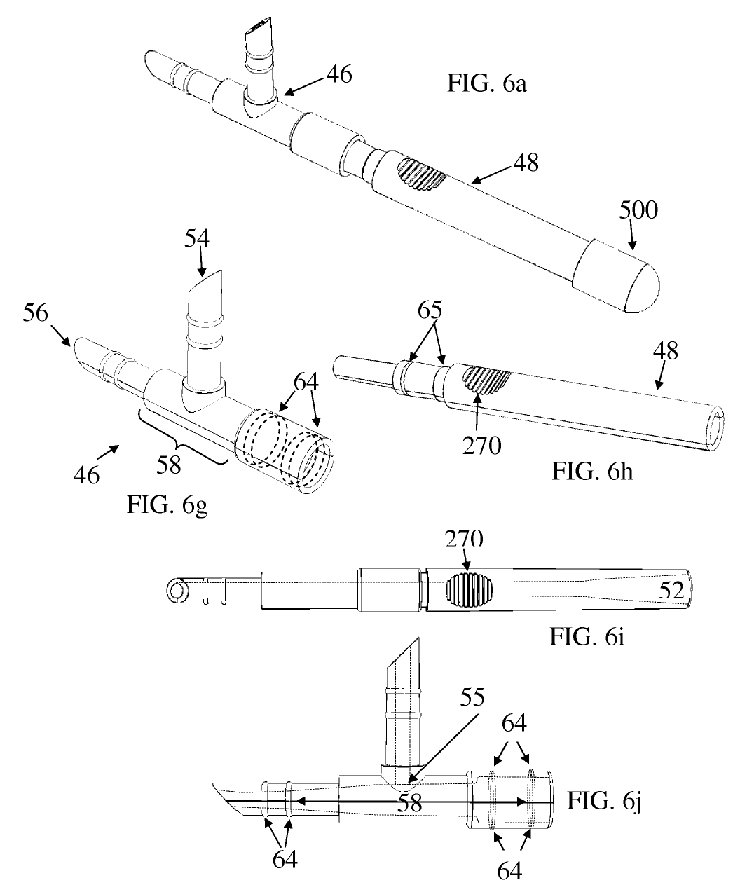

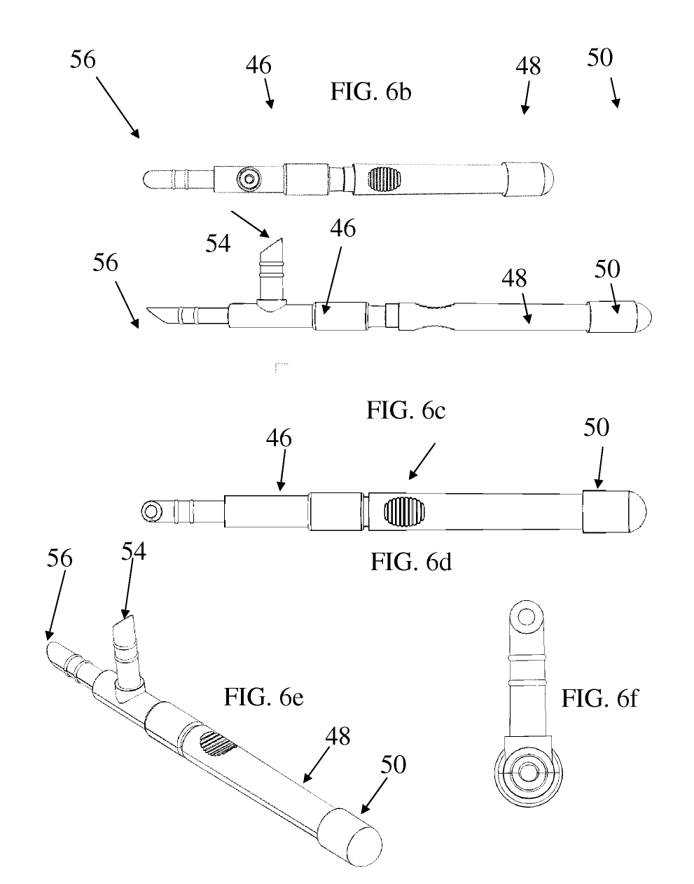

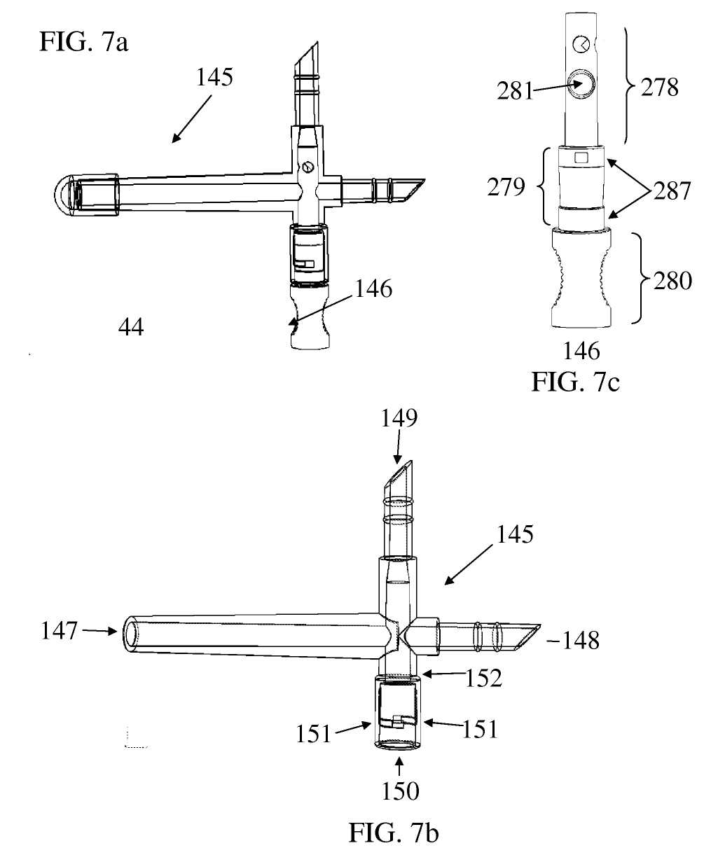

The other end of the supply hose 30 is connected to an action valve 40. The present invention may be used with a double action valve 42 (FIGS. 6a-6j) as well as with a triple action valve 44 (FIGS. 7a-7c).

These two types of valves are fundamental to the infusion of the culture medium to the uterus and for the reception and safe transportation of the embryos to the collector device.

The double action valve 42 comprises a fixed section 46, a mobile section 48, and a plug 500. The valve 42 controls the supply of the culture medium and receipt of the uterus discharge; thus the embryos are slipped gently through the funnel 52 that hides in the bifurcation 55. This eliminates the risk of the embryos being violently hit.

The T-shaped section is called fuselage and is characterized because it is the fixed section 46 of valve 42 which has a lateral supply duct 54 that feeds the system with the culture medium, a discharge conduit 56, and a chamber 58 that in its interior has a number of sound strips 64 for displacement movement and airtight adjustment where it moves in a controlled manner the mobile section 48.

The mobile section 48 is the part of the valve 42 that connects to the Foley catheter (not shown) that in turn is inserted into the uterus of the animal. The mobile section 48 is characterized because it can be easily moved through the grip and ergonomic handling system that allows to naturally accommodate the thumb and index fingers over the two airtight adjustment rings 270, so that to move forward, it opens the duct 54 of the fixed section 46 that feeds the system culture medium to the system, and moves back, closes the duct 54 at the same time that hides the bifurcation 55 so the embryos flow totally safely without exposing them to any trauma. Another special feature of the mobile section is the edge and the auxiliary side strips of adjusting and airtight setting that are connected inside of the fuselage to prevent slips and to delimit with sound the displacement of the mobile section inside the fixed section.

In addition, the part of the mobile section 48 that connects to the Foley catheter has the particular form of a funnel 52 which forces the elastic wall of the Foley catheter to connect inside the mobile section 48, such that the joint between these two parts form a connection without borders causing the uterus discharge to flow free through the funnel 52 that forms and characterizes the interior of the mobile section 48, which contribute to the embryos slipping through without obstacles to the discharge hose 50.

The mobile section 48 of the double action valve is responsible for opening, closing, and hiding the supply duct producing with it movement and an indicator sound, characterized by their internal design funnel-shaped 52 for the careful reception of embryos.

The plug 500 has as a function to avoid the penetration of atmospheric pollutants inside the system, and also supplies and maintains full the culture medium hoses, thus when the Foley catheter is connected to start uterus washing, they are loaded with fluid and not with air.

Another special feature that distinguishes the double action valve 42, is that it has a sound system which indicates when the supply duct is open to feed the culture medium, and when it is closed to stop the supply flow and hide at the same time the bifurcation; the sounds are emitted by the contact between the fuselage strips 64 and the strips of the mobile cone 65.

### Triple Action Valve

The triple action valve 44 (FIGS. 7a-7g) is a control and management device for fluids used to direct the supply of the culture medium to the uterus or to the collector device 60, also serves to receive and conduct the uterus discharge to the collector device 60. It is characterized by the opening and closing mechanism having three predetermined movements to connect in one or another direction of the valve internal ducts:

1. to supply the culture medium toward the uterus;
2. to transport the uterus discharge to the collector device; and
3. to transport the culture medium towards the collector device.

Said mechanism allows the operator to choose where to send the culture medium flow or the uterus discharge.

Comprises a fixed section 145 having a form of a cross and a mobile section 146 that moves inside the fixed section 145 connecting the different fluid conduction channels.

The fixed section 145 is characterized by its four ends: the connector funnel 147 for the Foley catheter, the discharge end 148 that connects with the discharge hose, the supply end 149 that connects with the supply hose and the end 150 that connects with the mobile section. The funnel 147 for the Foley connector has the same characteristics as the one for the double action valve 42 and the supply and discharge ends are also slanted to avoid the formation of connections with edges that endanger the physical integrity of the embryos and also to facilitate the connection with the hoses. Finally, the end 150 by where the pivot is connected to the fixed section 145 of the valve, characterized by a chamber having vertical grooves 151 which force and serve as guides to the mobile section to move in a single plane, also by the horizontal notch 152 that controls the displacement of the mobile section to the sides, since it catches and retains the top of the mobile section so that it can only move to that point, and from this to one side by a twist of the mobile section.

The mobile section 146 called pivot is characterized because the flow channels are integrated to its axis, which at the same time are designed in two segments 278 279 that move inside the fixed section 145, forced by the control notches movement predetermined in order to close or allow the flow of the fluid, and a third segment 280 called retention and manipulation knob that moves outside the valve with the fingers of the hand.

The segment 278 corresponds to the top end that it is the thinnest part of the axis, which is characterized because at the top has a duct 281 by the center of the axis that communicates in an “L”-shape with the first two ducts separated and intercommunicating together by an angle of 90°, the same which is intercommunicated with the fixed section 145 on the movements of the mobile section 146.

The segment 279, is characterized by being of a larger diameter than the segment 278 but above all by the two top connection guides 282 with the vertical notches on the fixed section, same that force the pivot to move on a single plane down so that the top guides on the top side reach the horizontal notch 152 of the fixed section 145, communicating in this way the supply hole with the uterus, or with the collector by means of a 90° rotation of the mobile section. Another feature of this segment is the horizontal high reliefs that serve to the adjustment and airtight seal, as well as the top for the control of the displacement of the pivot inside the fixed section.

Finally the third segment 280 corresponds to the grip and handling knob, which is characterized because it can be moved with the thumb and index fingers in view of the ergonomic depression that allows holding it with security and firmness.

### Apparatus Collector

FIGS. 8a-8e show the collector device 60 of the present invention. The collector device comprises a tray-shaped receptacle 78. Inside the collector device 60 can be found the embryos receptor 70, the main filtration and drainage system 80 and the secondary filtration and drainage system 90. In addition, the collector device 60 includes the main funnel gate 100, residues the expulsion control valve 110 of the secondary funnel, and the fastener 120.

The main filtration and drainage system 80 and the secondary filtration and drainage system 90 are located in different slanted sidewalls of the collector device 60. As can be seen on FIGS. 8a-8b, the secondary filtration and drainage system 90 is located below the level of the main filtration and drainage 80 system.

The receptacle 78 is covered with a lid 79 (FIG. 11) which has an entry valve 81. The entry valve 81 is one of the improvements to the present invention. The valve 81 is made of any elastic material that allows to accept and air tightly seal differently the diameters of hoses, whether regular or irregular.

In one embodiment of the present invention, entry valve 81 is made of a material that has memory to allow the entry valve to close itself when the hose is retrieved or by means of a stopper (86) that is located as an extension to the valve as shown in FIGS. 8c, 8d, and 8e.

Entry valve 81 is connected to one end of the discharge hose 50 and in the other end to a tube 82 located in the receptacle 78. The discharge tube 82 extends from the interface with the entry valve 81 up to the bottom of the embryos receptor 70.

The bottom of the collector device 60 is equipped with two search areas for the location of embryos, the first area is located in the center of the bottom.

of the collector device and is enclosed by a wall that rises diagonally on both sides to finish on an edge in order to facilitate the visibility; and the second area that surrounds the first area and occupies the rest of the bottom of the device.

### Embryos Receptor

The embryos receptor 70 (FIG. 9) is one of the innovations of the collector device 60 according to the present invention. The embryos receptor 70 provides a continuous system of admission and discharge where the fluid that reaches the first chamber, does not mix with the fluid that leaves the chamber at the same time by main filtration and drainage system 80. This technological feature of the device allows to control the place where the embryos and the mucosal should move and stay until collection process finishes.

In addition, the embryos receptor 70 is characterized because it allows the control of the uterus discharge in the interior of the device, controls the direction and force of the turbulent current to keep the embryos and mucosal in specific areas of the device without hitting or being dragged to the filtration mesh.

The embryos receptor 70 forms a reception chamber that receives the uterus discharge in immersion directed to the surface to suppress the force while entering the fluid filled chamber reducing the flow speed while entering the chamber and rising until emerging spreading on the surface where it fades and transforms the force into weight which ejects pressure over the lower fluid layers, inducing the discharge of the same amount of volume that is admitted in the form of laminar flow.

The embryos receptor 70 is inserted inside the collector device 60. It may have any geometric form, preferably a conical form. In addition, it may be made of any material known in the art that does not alter the properties of the embryos. It is preferable that the walls of the embryos receptor 70 surface be very soft and that they do not present any roughness to avoid damaging the embryos.

The embryos receptor 70 has at least two fins 88 in the outer wall that form three chambers 72, 74, 76 inside the collector device 60. These chambers intercommunicated through channels, siphons 77 and outfalls 75 that work together with the filtration and drainage systems 80 and 90 to control what is admitted and released from each of the chambers. In addition, the embryos receptor includes a support fin 89 which helps to stabilize the receptor.

Receiving the uterus discharge in the embryos receptor 70 allows to impulse the embryos to the surface to remain circulating to the rhythm of the turbulence, without crashing or rubbing against the inner walls, suspended along with mucosa away from the channel that discharges from the bottom of the adjacent chamber; when the discharge ceases, the embryos precipitated accommodating in the bottom, where they remain within being removed by subsequent discharges.

In addition, the internal dispenser has a siphon 77 that works automatically to regulate the fluid level between different chambers. Also, the system of outfalls of the internal dispenser has a fluid discharge gradient ranging from less to higher capacity between chambers, in order to remove the excess without generating drag or suction of the particle.

The first chamber is the embryos receptor chamber, wherein the second chamber is the shelter chamber; wherein the third chamber is the excess chamber; and wherein the chambers are contiguous and are also communicated.

The first chamber 72, called receptor chamber, receives the uterus discharge through an orifice 71 located at the bottom of the embryos receptor 70. The fluid flow that enters the receptor chamber 72 is directed upwards to the center of the surface, to impulse the embryos along with the mucosa to keep circulating in the top of this chamber while transferring through the bottom, to the next chamber, the same amount of fluid that is admitted, this particular form of receiving and managing the uterus flow discharge, weakens the strength of the current entering into the fluid filled chamber and when trying to rise to the surface, disappears as soon as the current emerges spreading in the surface, and transforms it into an alternative laminar flow, that gently pushes the bottom layer to the contiguous chamber through an internal channel 86 that interconnects and automatically regulates the level of fluid between these two chambers without generating particles drag and without mixing what is admitted into the device with what is discharged by the outfall and the auxiliary siphon spilled in the next chamber.

This technical feature does not allow the embryos to have the opportunity to crash into the interior while moving to the rhythm of the turbulence, because they are impulse to circulate in the top of the chamber while the excess is discharged from the bottom; neither allows the embryos to be embedded in the mucous membranes because they do not have a way to retain them, since the mucous themselves do not have a way to retain.

The second chamber 74, called shelter chamber is contiguous and communicated with the receptor chamber, presses the fluid layer to allow its remains in the bottom as it is filled up and until it spills layer on the surface, without mixing what is admitted with what is discharged. Basically, this chamber takes care of all of the remaining excess of the dragging force that the fluid may have when it enters in this chamber, because at the same time that admits fluid by the bottom, spills fluid at its top, the same amount that is admitted, without giving opportunity embryos and mucosal who managed to get to the bottom of this chamber, to raise to the outfall that spills in the adjacent chamber. Another feature of this chamber is the small siphon 77 which serves to automatically regulate the level between the different chambers, either when the fluid is discharged by the main filtration and drainage system 80, or when it is drained by the secondary filtration and drainage system 90.

The third Chamber 76, called excess chamber, comprises the area that houses all the fluid that must discharge from the device. This chamber includes the filtration and drainage system that comprises a main filtration and drainage system 80 when it is collecting, and a secondary filtration and drainage system 90 when it is required to concentrate on the bottom a small volume of fluid to facilitate the search of embryos with the microscope.

The outfall system of the embryos receptor has a fluid discharge gradient ranging from less to higher capacity between chambers, in order to remove the excess without generating drag or suction of the particle.

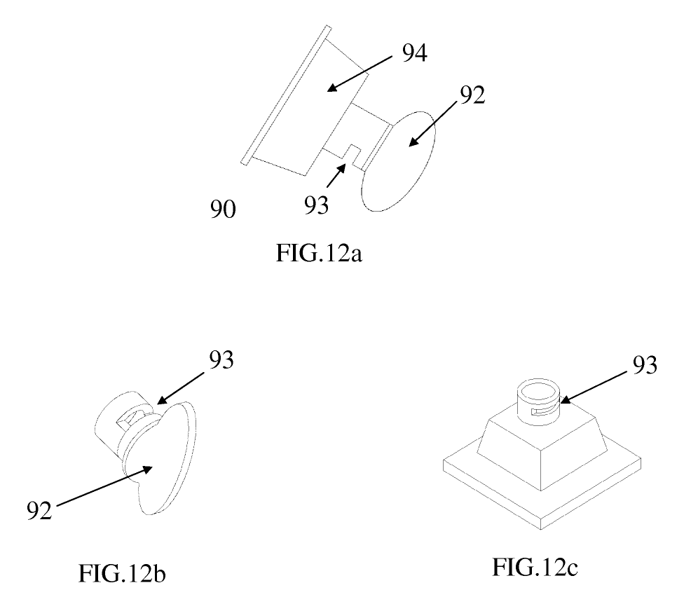

The gate 100 of the main drain system 80 (FIG. 12) is another improvement of this invention. This gate is used to prevent the entry of dust or any atmospheric pollutant to the interior of the collector during the collection, since it automatically opens by the pressure of the laminar flow that is expelled by the drainage, and because it automatically closes when the weight of the gate defeats the pressure of the laminar flow. This feature forms an automated system that allows the waste to leave without giving opportunity to dust or other pollutant to enter the device.

Another technological improvement the device has is a main filtration system that is mobile. Characterized because it can disassemble and sufficiently rotate to allow the washing of the filtration mesh by its natural side to remove what is embedded on it, in addition, because such rotation allows that anything that falls from the mesh falls into the bottom of the device.

The secondary filtration and drainage system 90 is another technological improvement whose importance is that it manually controls the discharge of waste by drops or by jets and serves for discharging all the fluid that you must exit the device reducing the volume and the depth of the culture medium inside to a minimum, to reduce the particles sedimentation inside to facilitate the search and location of the embryos. This system comprises a cap 92 and the funnel 94 respectively. These two pieces work jointly when the rotating cap 92 by the butterfly, matches the slot of the cap 93 with the slot of the funnel for the fluid to escape, easily controls the output speed, either by just opening it and letting it drip or fully matching the two slots for a full speed flow, jet.

In addition, the cap 92 of the secondary drainage system has ergonomic wings for gripping and handling.

In addition, the embryos receptor forms a sedimentation chamber system that allows the precipitation particles in suspension before reaching the chamber where the filtration and drainage system is located.

Another innovation of the present invention is that the collector device 60 comprises a fastening system 120 forming an integral part of the collector that serves to support the device on the belt or on any surface or place where it can be inserted into the collector device to support it. This facilitates the collection of embryos by allowing the use of the collector device without any assistants, without special accessories, and especially in anywhere you need work.

Additionally, the system includes retention needles inserted in the first level of the collector device, one located in the shelter chamber and the other in the same level but in the opposite wall.

The needle retention system 156 (FIGS. 8f and 8g) is a concept of the device to hold the mucosal outside of the visual field of the collector, with the idea that they do not obstruct the view when locating the embryos, and with the objective to keep them immobile while reviewing and extracting the embryos embedded in them. Characterized because the tip of the needles allows it to easily engage them with the simple act of placing the mucosal on them; simply a tool to fasten the mucosal.

### Use of the Embryos Collector Device

Exposing the innovative parts, as follows, describes how the collector device works:

When the expert is going to extract the embryos from the female donor, which was previously immobilized in a trap and the matrix connected to a Foley catheter, start by connecting in the laboratory the system of the present invention with the source of the culture medium by the perforated tip of the supply valve 20. Then, the action valve 40 (double action or triple) opens to fill the hose system with the culture medium until the internal level rises and covers the place where the discharge hose 50 spills its content, so that the first uterus discharge is received in immersion, then, the action valve 40 is closed. Previously, the discharge hose 50 has been blocked when the device is being used with the double action valve or with the closing movement if the triple action valve is being used, in order to maintain full fluid of the hoses in preparation to connect with the Foley catheter.

Then, the user needs to go to the trap where the cow is, and immediately needs to place or secure the culture medium source to a specific height anywhere that allows the filling of the uterus by gravity. Then, the collector device 60 is secured to any place, including the user's belt where it can be grabbed by using the fastener 120, as long as it is at a lower level than the uterus, to ensure the discharge by gravity. Then the plug 500 is of the action valve 40 is removed to connect the valve to the Foley catheter valve, having special care that the connection between these two parts, is centered; thus, a continuous duct is formed.

Then, the action valve is opened to flow the culture medium toward the uterus, by sliding forward the mobile section 48 when the double action valve is being used, or with a twist on the knob if the triple action valve is being used, and then the hand is introduced into the rectum of the cow to verify that the uterus is successfully filled with fluid or is in that process.

Later, once the uterus has sufficient culture medium without overflow, stir to detach the embryos from the endometrium, the uterus is then evacuated, being sure that the action valve opens the duct that communicates with the collector device, which, depending on which of the two valves are being used, it is accommodated, thus the duct that communicates the Foley catheter with the discharge hose, allows the passage of the uterus discharge, if the double action valve is being used, first the mobile section 48 is retracted to close the supply conduit 54 and to hide at the same time the bifurcation 55, and then, the hose clamp of the discharge hose 50 is released. If the triple action valve is being used, the retention knob needs to be risen to free the uterus discharge and transfer its content to the collector device 60. Which, receives the uterus discharge in the receptor chamber 72 and the embryos are impulsed toward the surface to remain circulating to the rhythm of the turbulence, without crashing or rubbing against the internal walls, suspended along with the mucosal, away from the channel 86 that discharge in the contiguous chamber, until the chamber 74, fills and spills in the excess chamber 76, which is also slowly filled up until expulsed by the main filtration and drainage system 80, the same amount of fluid that is admitted.

This time of filling and evacuating the uterus is repeated as many times as the technician deems it necessary, and the wonderful feature of this system is that with each discharge of the uterus, the embryos precipitate accommodating in the bottom, where they remain without being able to be removed by subsequent discharges. So, when the last uterus evacuation ends, the embryos are found in the bottom of any of the first two chambers, without any possibility of being dragged into the drainage, so to finish with the uterine embryo extraction, the action valve 40 is disconnected from the Foley catheter and the plug 500 is placed in again, to open the action valve again, to pass through the discharge hose 50 an amount of sterile culture medium in order to drag inside of the collector device 60 any residues of the uterus discharge.

Then, the discharge hose 40 is disconnected from the collector device 60 and the hole 85 is covered with the cap 86 to then proceed to drain the collector device using the secondary drainage system 90 to reduce to the minimum collected volume in order to easily transport it to the laboratory.

Once in the Laboratory, it is left to stand for at least a minute before you remove the lid 79 and the embryos receptor 70, then if necessary, the mesh is disassembled and rotated to wash it, before placing it on the microscope, ready for the search and location of the embryos.

In view of the above, it can be affirmed that the technological innovations defined a new embryos collection system characterized by the safety to receive, transport, retrieve, locate, and manipulate the embryos with unmatched facility, providing a duct system that connects the uterus to the collector device, without bifurcations, edges, nor walls that impede the free flow of the embryos; since a contiguous outfalls system controls the force and direction of the uterus discharge inside the collector device so the embryos can only go and stay in specific places of the device where they do not have a chance of hitting or of passing unnoticed embedded in the filtration mesh or in the mucosal; and, finally, to locate and manipulate the embryos, because all of them remain in the bottom of a chamber that has these characteristics of safety in the different instruments that are used to extract embryos.

1. A system for collecting embryos and mucosal comprising:
a supply valve, wherein the supply valve includes a first end and a second end and is adapted to connect on the first end to a culture medium source;
a supply hose connected to the second end of the supply valve;
an action valve, wherein the action valve contains a first end, a second end, a third end, and a fourth end, wherein the first end is connected to the supply hose;
a discharge hose, wherein the discharge hose includes a first end and a second end, wherein the first end of the discharge hose is connected to the second end of the action valve;
a collector device connected to the second end of the discharge hose;
wherein the collector device includes an embryos receptor, the main filtration and drainage system, a secondary filtration and drainage system, and a fastener;
wherein the embryos receptor comprises a plurality of fins on the exterior side, which divide the collector device in different chambers;
wherein the chambers are intercommunicated through channels, siphons, and outfalls that work together with the main filtration and drainage system and the secondary filtration and drainage system to control what is admitted and released from each one of the chambers.

2. The embryos collector system according to claim 1, wherein the supply valve comprises:
in the first end a hollow perforation tip that connects the supply valve with the culture medium source;
in the second end a transparent flow chamber comprising a cylinder having controlled movement guides and a float, wherein the movements guides control the movements of the float between an admission orifice and a discharge orifice.

3. The embryos collector system according to claim 2, wherein the hollow perforation tip is conical and multi-dimensional to perforate and tightly seal different entrance orifice diameters.

4. The embryos collector system according to claim 2, wherein the cylinder is transparent and the float controls by gravity forces the admission, and automatic closing of the supply valve against the flow.

5. The embryos collector system according to claim 2, wherein the float allows the flow of the culture medium only in one direction by the gravity force.

6. The embryos collector system according to claim 1, wherein the action valve is a double action valve and comprises:
a fixed section;
a mobile section; and
a plug.

7. The embryos collector system according to claim 6, wherein the fixed section valve comprises:
a supply duct that feeds the system;
a discharge conduit; and
a chamber;
wherein in the interior of the chamber a mobile cone is connected, slides, and moves in a controlled manner through a series of sound strips with airtight adjustment.

8. The embryos collector system according to claim 7, wherein the end of the supply duct and the end of the discharge duct are slanted to facilitate the insertion of the hose and to form a connection without internal borders that can prevent the free flow of embryos in any direction.

9. The embryos collector system according to claim 6, wherein the mobile section of the valve is adapted to be connected to the Foley catheter;
wherein the mobile section is in charge of opening, closing, and hiding the supply duct producing with its movement an indicator sound;
wherein the mobile section has an internal form shaped as a funnel for the careful receipt of the embryos;
wherein because of the funnel shape of the Foley catheter the catheter connects inside the funnel forming a continuous duct without borders and walls, which obstruct the free movement of the embryos.

10. The embryos collector system according to claim 6, wherein the supply and discharge hoses are filled by the action of the plug.

11. The embryos collector system according to claim 6, wherein the double action valve includes a sound indicator system which emits a particular sound when it is open to give pass to the supply of the culture medium, and other sound when it is hiding the bifurcation to give pass to the uterus discharge.

12. The embryos collector system according to claim 1, wherein the first chamber is the embryos receptor chamber, wherein the second chamber is the shelter chamber; wherein the third chamber is the excess chamber; and wherein the chambers are contiguous and are also communicated by a system including canals, siphons and outfalls.

13. The embryos collector system according to claim 12, wherein the receptor chamber receives the uterus discharge in immersion from its bottom and directed to the center of the surface, to control the direction and force of a turbulent current formed while entering to a fluid filled chamber, wherein the turbulent current forces are transformed into weight which applies pressure over layers at the bottom of the receptor chamber inducing the discharge of the same amount of fluid volume that is admitted in the form of a laminar flow.

14. The embryos collector system according to claim 12, wherein the excess chamber includes the main filtration and drainage system and the secondary filtration and drainage system.

15. The embryos collector system according to claim 13, wherein the system of channels, siphons, and outfall works automatically to regulate the fluid level between the different chambers to control what is admitted and what is discharged from each chamber and the collector device, to control the strength of the turbulent current from the uterus discharge in the interior of the collector device and to control the movement and places where the embryos and the mucosal should stay during the collection, search, and location of the embryos.

16. The embryos collector system according to claim 12, wherein the embryos receptor also includes a siphon that works automatically to regulate the fluid level between the different chambers.

17. The embryos collector system according to claim 1, wherein the collector device also includes a cap having an admission valve made of an elastic material that accepts and seals different hose diameters; wherein the elastic material has memory to allow the admission valve to close by itself when the hose is removed.

18. The embryos collector system according to claim 1, wherein the secondary filtration and drainage system comprises a cap and a funnel;
wherein the cap comprises a slot;
wherein the funnel comprises a slot;
wherein when the cap rotates, the slot of the cap matches the slot of the funnel controlling the discharge speed of the fluid.

19. An embryos collector device according to claim 1, wherein the bottom of the collector device comprises two search areas for the location of embryos, the first area is located in the center of the bottom of the collector device and is enclosed by a wall that rises diagonally on both sides to finish on an edge in order to facilitate the visibility; and the second area surrounds the first area and occupies the rest of the bottom of the device.

20. The embryos collector system according to claim 1, in which the action valve is a triple action valve comprising:
a fixed section having the form of a cross;
a mobile section that moves inside the fixed section;
a plug;
wherein the triple action valve comprises three predetermined movements to connect in any direction the valve internal ducts:
wherein the fixed section comprises:
a connector funnel adapted to be connected to a Foley catheter;
a discharge end connected to the discharge hose;
a supply end connected to the supply hose;
an end that connected to the mobile section;
wherein the mobile section comprises:
an axis;
flow channels integrated the axis;
a first segment;
a second segment, wherein the first segment and the second segment move inside the fixed section, wherein the first segment and the second segment comprise control notches to close or allow the flow of the fluid; and
a third segment that moves outside the valve and is manipulated with the fingers of the hand.
